(19) United States
(12) Patent Application Publication
(10) Pub. No.: US 2008/0134522 A1
(43) Pub. Date: Jun. 12, 2008

(54) Grounds maintenance tool and process for making same

(76) Inventor: Edward P. Hurley, Sarasota, FL (US)

Correspondence Address: Edward P. Hurley, 1214 Western Pine Circle, Sarasota, FL, 34240, US

(21) Appl. No.: 12/006,420

(22) Filed: Jan. 2, 2008

Related U.S. Application Data
(63) Continuation-in-part of application No. 11/008,037, filed on Dec. 9, 2004, now abandoned.

(51) Int. Cl. B26B 7/00

(52) U.S. Cl. 30/276

(57) ABSTRACT

A grounds maintenance tool sends power to a grounds trimming or lawn edging orthogonal isometry from about an identical transport route, the tool orthogonal isometry is orientated by an upright power control handle and a three-way lateral control handle that is sometimes used as a bar arm, the power control handle provides a rear arm rest that also contains shaft stops and a power control trigger with one or more speeds to keep an index finger in about identical tool operating frameworks, the longitudinal power control handle, lateral control handle and the auxiliary shoulder harness creating a congruent orthogonal isometry on the shaft center of rotational symmetry, the cutting disk bringing the string line filament inner and outer spool out in radius to obey elasticity laws, the cutter stabilizes quickly, the guard side walls are folded to wing ends, the three main skids are stabilizers and the arm rest is a wand.

### CROSS REFERENCE TO RELATED APPLICATIONS

This is a continuation in part of Ser. No. 11/008,037, filed on Dec. 9, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of lawn care and more specifically to a grounds maintenance tool and process for making same.

Demand for lawn care equipment in the United States is expected to reach $10.7 billion in 2009. This is likely because American home lawns are relatively large, its economy is consumption based and the global lawn industry continues to promote new cutting edge innovation. The US lawn care market is made up of about two-thirds commercial and one-third residential equipment dealers with a significant percentage of landscapers converting their string trimmers into lawn edgers. With such a large and diverse lawn tool trade market, it is important that consumers know the differences between these two horizontal and vertical turf grooming practices.

Commercial landscapers prefer to use gear driven brush cutters to keep a fast pace trimming route through thick brush. Straight shaft brush cutters typically facilitate string line filament on lawns for more torque and a slower head speed to buzz through vegetation with little resistance, sometimes in difficult to reach or view spots. This is a case where a straight shaft turtle will out run a high speed curved shaft rabbit to eventually chop down a large tree with a slower speed gear ratio. Many arborists have a difficult time promoting brush cutters for that very reason and will only recommend garden bed edging techniques after receiving feedback that straight shaft cutting planes opened up some serious horizontal cut wounds around tree bases for entry of unwanted pests. In addition to pest issues, lawn equipment safety standards require that straight shaft brush cutters be longer than normal residential lawn trimmers to meet the needs of taller grounds maintenance individuals. It is crucial that tall lumber jacks hold longer brush cutters in balance when cutting tree saplings due to the potential of lateral kick back and because of the orthogonal stress it can put on a torso. This is why some brush cutters come equipped with lateral bar arms or a two-way bull horn handle.

Brush cutters are linked to a global forestry market with an objective of maintaining, harvesting and replanting trees. Accordingly, outdoor power equipment manufacturers will want to mesh their global forestry assembly line with lawn power tools production. This merging of industries poses a problem when most metallic brush cutters facilitate tree sapling horizontal cuts whereas the American lawn market has more than fifty-percent of lawn tools sold as horizontal string trimmers and lawn edgers. Initial horizontal ground level forestry constraints outside of a boom application may lean the competitive forestry OEM industry into designing lawn tools like their chainsaws with a limited horizontal cut method. As eluded to earlier, forestry equipment dealers will likely sell high torque and cool sounding motor features which may play a part in OEM decisions not to separate lawn and forestry brush cutters parts from the assembly line. Consequently, untrained grounds workers may attempt to lawn edge with vertically imbalanced brush cutters having a high potential of causing them to let go of the handle to grab a hold of another element on the brush cutter center of rotational symmetry. It's going to happen and hard to stop from happening.

Outdoor equipment manufacturers have already attempted to correct the rotational constraints of multi-task forestry and lawn care products by adding string line filament cutting heads to their line of steel brush cutters. Although far safer to use than metallic cutting blades, string line filament brush cutters still pose a serious risk to end users and their property because (1) A two-fold rotational method for horizontal trimming and vertical edging will expose the edging operation to an operator, edging operation is directed significantly away from the transport path which can put strain on a neck and obstruct the view of oncoming objects and could cause injury when a significant portion of string line filament is used to complete work or (2) A pre-fold horizontal trimming and vertical edging route can cause fuel motors to be located near sensitive breathing passages or encourage the removal of cutting guards because the lawn edging angle is flawed. Having a flawed edging angle by design encourages operators to remove cutting guards which will be explained more in detail below. When lifting up string line filament from a grounds surface at a predetermined speed for lawn edging, it is believed that the outer segment length hitting a pavement is directly proportional to hand-arm wave frequency injuries. In an attempt to solve this conflict, many lawn tools have been purposely designed with a pre-fold lawn edging method in order to maintain a low height for lawn edging. However, a horizontal leaning pre-fold angle for edging can wear out the lower segments of string line filament proportional to its vertical leaning complimentary angle, thus leaving more questions to be answered. One can assume that a pre-fold lawn care method may cause serious harm to some of the best landscapers on the planet.

Lawn equipment dealers may offer shorter bent shaft string trimmers to their patrons as a low cost alternative to brush cutters. Bent shafts generally produce higher speeds and lower torque for lawns which some arborists will promote as a last alternative to those persistent pests that insist on horizontal yard trimming along tree perimeters. However, shorter bent shafts may expose the tool area to the about average thirty-one inch stride of an operator. It can be determined that a two fold lawn grooming framework will orientate the horizontal trimming operation to the north of a transport route and the vertical lawn edging operation to the east or west of a transport route. The two-fold bent shaft landscape method mostly constrains workers to a forty-five degree height angle, thereby limiting height variations and shaft lengths for many taller end users of lawn tools. Furthermore, the leading edge of the curved shaft string line filament must is generally held about three inches off the ground by an elongated bent shaft and should further be raised about another five inches off the ground for lawn edging which in many cases doesn't meet a plastic elasticity limit. Moreover, a wider two-fold lateral cutting and motor operating framework can put stress on a body by pulling an index finger and other body parts further away from a transport path. A two-fold cutting framework is clumsy because the east or west tool position for lawn edging diminishes the view of a transport path and perhaps there is less leverage to slowly elevate string line filament to an optimal holding point. Many combination grounds trimmer and lawn edger asymmetrical curved shafts could be uncomfortable to use increasing the odds that they will remain in the tool shed. Currently, there are a few bent shaft methods to orientate lawn tools in two-fold equilibrium, but the downward bend facilitated for trimming shortens the length of the shaft that an operator can stride into.

Bent and straight shaft trimmers typically include cutting guards that can flip upside-down in a two orthogonal fold method for lawn edging, further adding risk to an operator for being injured. Historically, owner's manuals have purposely warned landscapers against removing cutting guards because of customer feedback involving hand/arm related stress injuries possibly related to a three inch tool origin for horizontal trimming being about five inches lower than an eight inch tool origin for vertical edging. There are even some lawn tools that allow a cutting guard to pivot upward towards an operator which exposes trimming operation to an operator. Surprisingly, more than fifty-percent of combination trimming and edging commercial lawn tools come into the repair shop with their cutting guards removed according to a 2006 Van Wall Equipment personal survey taken in Olathe, Kans. Although the Van Wall report requires more investigating, the isolated problem may explain why lawn tools are perhaps the second or third leading cause of accidents among American high school students. In addition, cutting guards should substantially hug a lawn edge or surface and this is only possible for single-fold lawn care. There could be another reason why asymmetrical or symmetrical cutting guards are removed from operative power tools if any of the side walls won't line up with the lawn surface. String trimmers with straight or bent shafts should have cutting heads with cutting guards that maintain good balance and proper rotational symmetry.

Lawn string trimmers are dominant in the United States because many cities have ordinances and deed restrictions on how tall grass can grow before a fine is assessed on violators. When having to cope with many regulations, some Americans will take the more affordable path. This is why a high percentage of manufacturers will install inexpensive D handles with a two spoke design onto lawn power tools. However, the work can become cumbersome requiring an interchanging of the D handle with a bull horn handle that requires more lateral swing balance. Plus, it has been recognized that extra spokes add structure to a handle while being capable of reducing weight and will control vibration more evenly. Vibration caused by disturbances is very common in lawn care which can make operators more susceptible to stress injuries when asymmetrical shaped D handles are used. Having less symmetry for lawn edging, the D handle may transfer longitudinal, lateral and vertical tension to an operator from either a power source or tool region. Accordingly, lawn work can easily be done with common everyday D handles, but the operator may become fatigued when the handle is not properly fitted for lawn trimming and edging. Handles should have uniform circular tension and suspension during operation in order to stabilize resistance factors more evenly. A bar arm is sometimes fastened near D handles to prevent such an event from occurring. However, lateral bar arm interchanging or placement brings us back to the dilemma of adding more elements to power tools when the real problem could simply go away by having equilibrium. Bar arms or bull horns are practical for heavy brush use, but the question remains if landscapers will take the time to remove and replace them.

Whether lawn tools need to be sold separately or combined for use, they do help landscapers perform difficult lawn chores. The problem with selling individual handheld lawn tools separately is convincing businesses like Home Depot, Sears, Lowes and other fine lawn tool retailers that half their landscape isle should be reviewed in the same light as the auto industry mandated air bags which doesn't go over too well with loyal customers. Another alternative is to give customers what they want in a safe manner which is generally the best way to go.

It would be beneficial to bring a uniform handle, safe cutting guard and cutting tool assembly to market for a single-fold operation where the leading edge and tip of string line filament will substantially maintain equilibrium. Several types of handles, disks and power sources have been developed for multiple lawn tool applications. However, most of these products have fast moving parts that can translate or rotate away from a forward transport route or problems continue to take hold with a flawed pre-fold cutting method. Apparently, there doesn't seem to be a simple way to bring affordable, more balanced combination trimming and edging grounds maintenance tools to market which this application tries to address in a single-fold lawn application.

One such handle from U.S. Pat. No. 7,131,499 B2 orientates a frontal control handle to the far east or west side of an operator during edging operation with respect to a north orientation for trimming operation. This design is a disadvantage because the orientation shifts the operator's eyes and leg movement away from a forward progressing transport route or parallel oncoming traffic. Furthermore, the shield doesn't protect the operator from fast moving projectiles when the frontal handle is flipped over for edging operation. Wearing a shoulder harness may pull the device towards the operator during edging which could be dangerous. There doesn't appear to be good balance for reducing stress on an operator's torso unless the cutting tool is moved closer to the operator which can further be dangerous. These sandwiched motor and cutting tool machines rely on a frontal handle fulcrum which can swing towards an operator when loosing their balance. It takes twice as much work to fold U.S. Pat. No. 7,131,499 B2 into a second vertical isometry when comparing the operation to a single fold framework. Elevating or lowering the string line filament of this invention could fatigue an operator. The frontal handle appears to have more material than standard frontal handles which could be a cost factor.

The U.S. Pat. No. 6,415,585 B2 provides for a D shaped handle as a main disadvantage for lawn care when the side of the handle is gripped asymmetrically for lawn edging. The lawn edging cutting angle could cause tool imbalance which encourages operators to let go of the D handle which could be dangerous. A lawn edging angle wears more on the ground side of the cutter which can end up causing additional vibration disturbances. Without a vertical angle for edging this invention may further require a lateral bar to be installed for thick brush work, thus adding more costs and maintenance to lawn care service.

U.S. Pat. No. 5,661,960 claims to use a handle assembly for power line trimmers which retains the operator's fore arm into a shaft in a thirty-five to fifty-five degree longitudinal axis position to help guide the tool operation from a motor end. In addition, a wheel may be installed near the shaft trimmer end to help an operator guide a cutting unit. The main concern with this invention is that American lawn care is now turning more and more to vertical edging of lawn beds because of the damage lawn trimmers can do to property. The wheel of this invention could get stuck in a lawn rut. A lawn care provider may become suspended on the tool longitudinal axis when slipping which may only leave one free hand to help break a fall while attempting to push away from fast moving parts. Furthermore, the operator is more likely to bend the shaft by downward load resistance which could cause significant vibration. The brace can act as a vice to sandwich an index finger onto the throttle control trigger at wide open throttle after a full drop has occurred on a hard surface. Combined trimming and edging operation has many different elastic elements which this device appears to constrain. Lastly, grounds maintenance can be a sweaty profession and a top to bottom strapped on fore arm brace is likely to cause discomfort in that situation.

U.S. Pat. No. 6,179,737 B1 is a tool that can substantially maintain its stability when spun on a horizontal plane. The stability is made by using less material near the inner core and by providing a more elastic outer surface when being spun rapidly into areas like narrow intersecting fence lines. Although this invention takes aerodynamic features into consideration for the hand held operator, the main difficulty with this invention is that the tool is controlled in a horizontal plane which can gyrate when moving between

U.S. Pat. No. 5,661,960 claims to use a handle assembly for power line trimmers which retains the operator's fore arm into a shaft in a thirty-five to fifty-five degree longitudinal axis position to help guide the tool operation from a motor end. In addition, a wheel may be installed near the shaft trimmer end to help an operator guide a cutting unit. The main concern with this invention is that American lawn care is now turning more and more to vertical edging of lawn beds because of the damage lawn trimmers can do to property. A lawn care provider may become suspended on the tool longitudinal axis when slipping which may only leave one free hand to help break a fall while attempting to push away from fast moving parts. Furthermore, the operator is more likely to bend the shaft by downward load resistance which could cause significant vibration. The brace can act as a vice to sandwich an index finger onto the throttle control trigger at wide open throttle after a full drop has occurred on a hard surface. Combined trimming and edging operation has many different elastic elements which this device appears to constrain. Lastly, grounds maintenance can be a sweaty profession and a top to bottom strapped on fore arm brace is likely to cause discomfort in that situation.

U.S. Pat. No. 6,179,737 B1 is a tool that substantially maintains its stability when spun on a horizontal plane. The stability is made by using less material near the inner core and by providing a more elastic outer surface when being spun rapidly into areas like narrow intersecting fence lines. Although this invention takes much appreciated aerodynamic features into consideration for the end hand held tool user, the main difficulty with this invention is that the tool is released often from the grip of an operator in a horizontal plane which can gyrate when moving between ground trimming and lawn edging modes complimentary horizontal and vertical modes of operation.

U.S. Pat. No. 7,266,893 provides affordable means for grass trimming and edging with a two-part speed control switch. The motor is placed near the grounds region and the power source is put substantially on the other orthogonal power control grip. This invention is designed as a two-fold trimming and edging method which orientates the tool origin to the side of an end user with respect to a forward transport route. The overall weight of this machine is likely to be imbalanced with the fulcrum being set close to a lateral frontal control handle grip region. A few other disadvantages of having a frontal control handle fulcrum is that a longitudinal axis can not be easily secured to lower resistance levels created by variable string line filament elevations, the cutter can pivot into grounds projectiles (in trimming mode) and into bodily organs (in edging mode) when a hand suddenly dislodges from the other power control grip, the two-part motor speed control adds more capital costs to the process and an asymmetrical load put in front of an operator usually translates to more stress on a torso. Finally, the lawn edging operation further exposes string line filament and potential projectiles directly towards the worker.

### BRIEF SUMMARY OF THE INVENTION

The primary object of the invention is to provide a lawn tool that operates within one orthogonal isometry to perform safe grounds maintenance and transport.

Another object of the invention is to provide a lateral control handle that can be held comfortably by an operator with their left or right hand.

Still yet another object of the invention is for the lateral control handle to easily fit onto most elongated lawn tool shafts.

Another object of the invention is to provide means for a lateral and overhand grip for different lateral control handle hand positions.

A further object of the invention is to provide the lateral control handle with uniform bar spokes that will help stabilize the lawn tool from lateral kick back.

Yet another object of the invention is to provide a sturdy trimming and edging height adjuster at the lateral control handle yoke center of percussion.

Still yet another object of the invention is to provide the yoke with a lower skid that aligns with the cutting guard and power source lower skids to help keep the shaft from bending.

Another object of the invention is to provide a longitudinal power control handle that can be held by an operator with their left or right hand.

Another object of the invention is to provide the longitudinal power control handle with a back arm rest and lever instead of a full locking brace that controls vertical tool movement for a plurality of tool attachments.

A further object of the invention is to provide the operation with a way to slowly raise or lower the tool.

Yet another object of the invention is to provide a brake or cam lock that can quickly clamp the shaft and handles in place.

Still yet another object of the invention is to provide means for an auxiliary harness to substantially balance the lawn tool on either side of an operator's torso.

Another object of the invention is to provide means for uniform compression and suspension of the shaft inner workings with an optional harness, the power control handle and the lateral control handle.

Another object of the invention is to promote six or more different lawn care hand-arm exercises to shorten repetitive tool gripping cycles.

A further object of the invention is to provide a low and regular motor speed trigger for the purposes of controlling noise, allowing for slow motion along high risk slopes and to help with following governmental ordinances or standards.

Yet another object of the invention is to provide a ski type design at the base of each skid to help glide the lawn tool down slopes or to slow it down when being pulled backwards.

Still yet another object of the invention is to provide hand grips that orientate an operator's elbows comfortably back behind their torso.

Another object of the invention is to provide a bow shaft and shaft casing for a flexible drive shaft that reduces vibration and improves the balance.

Another object of the invention is to provide a cutting disk that brings a string line filament spool out to manageable suspension and compression dimensions.

A further object of the invention is to provide one or more cutting disk barrels on the cutting disk cover that can be interchanged or lengthened.

Yet another object of the invention is to provide an auxiliary cutting disk with a thin profile that has a standard length and weight for a typical lawn cutting head assembly.

Still yet another object of the invention is to provide dimples inside and out of the cutting disk cover to reduce weight and prevent membrane surfaces from binding.

Another object of the invention is to provide a cutting guard that protects the operator in an isometry operating framework.

Another object of the invention is to help provide a more stable lawn cutting operation.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a grounds maintenance tool comprising: a lawn tool consisting of a power source, the power source having means to transmit power from a shaft to a cutting disk or the like on a center of rotational symmetry, the cutting disk having means to lock within an orthogonal operating isometry on substantially identical transport routes, the power source maintains an upright position within the orthogonal operating isometry, the power source contained within a power casing, the power casing connected to an upper brace and arm rest, the power casing connected to a lower power skid, the power casing connected to a power control handle, the power control handle operatively connected to the shaft on a longitudinal axis of the orthogonal operating isometry, the power control handle having inner ring supports that hold the shaft in equilibrium, the power control handle having a longitudinal grip, the longitudinal grip having means for an operator to stabilize longitudinal operation with a rearward right or left hand, the longitudinal grip having means of assisting with downward lateral torque, the longitudinal grip having means for an operator to react quickly to lateral or vertical imbalances, the power control handle having a brake or the like to stop the shaft from rotating, the power control handle having a power trigger with one or more speed controls, the power trigger having means to keep an index finger substantially on the speed control trigger in all the lawn tool operating frameworks, the power control handle having an aperture that connects an auxiliary shoulder harness to the lawn tool, the auxiliary shoulder harness having means to the shaft on a vertical axis of the orthogonal operating isometry, the auxiliary shoulder harness having means to interchange the lawn tool to either side of the operator, the lateral control handle operatively connected to the shaft on a lateral axis of the orthogonal operating isometry, the lateral control handle having a horizontal grip for trimming lawns, the horizontal grip having means for an operator to stabilize the lawn tool lateral operation with a forward left or right hand, the horizontal grip having two adjacent side spokes, the side spokes providing a bar for an operator to grasp onto with a lateral grip, the lateral control handle having a right grip for lawn edging, the right grip having means for an operator to lawn edge diagonally to the right of the transport route with a forward right hand grip, the lateral control handle having a left grip for lawn edging, the left grip having means for an operator to lawn edge diagonally to the left of the transport route with a forward left hand grip, the lateral control handle having a yoke, the yoke having means for an operator to hold the shaft in equilibrium in all the lawn tool operating frameworks, the yoke may or may not be coated with an elastic gel material, the yoke having a handle skid that faces the operation, the lateral control handle right and left grips having means for the operator to lawn edge with a overhand, underhand or lateral grip, the lateral control handle trimming grip having means for the operator to lawn trim with a overhand, underhand or lateral grip, the lateral and power control grips substantially align with the operator's forward and rearward hand holding orientations, the cutting disk bringing the string line filament inner and outer spool out in radius to substantially stay within elasticity laws, the cutting disk is able to stabilize quickly, the cutting disk having one or more cutting disk barrels, the cutting disk having means to hold about the same length of string line filament as cutting heads known to the art, the cutting disk having a symmetrical cutting guard, the cutting disk having a disk cover, the disk cover having aerodynamic airfoils, the disk cover having aerodynamic dimples, the airfoils having means to untangle vegetation, the airfoils provide structural support for the string line filament bump and feed skid, the inverted trough provides a wake area to cool off the cutting disk, the airfoils substantially reduce noise in comparison to linear airfoils known to the art, the dimples reduce tool weight, the dimples keep dust away from the spool, the cutting guard may have a standard knife or a bladed claw to chop off string line, the cutting guard radian is generally two times the shaft hypotenuse angle, the cutting guard substantially aligns with the lawn surface and lawn edge, the cutting guard side walls are aerodynamically folded towards a back wall, the back wall having small wings that flare out to prevent most debris from dispersing towards the operator, the cutting guard having a tool skid that glides the lawn tool with forward movement, the tool skid slows backward movement, a grounds wheel may or may not be used in embodiments of this invention, the lawn tool having the power skid, the handle skid and the tool skid all line up to suspend the shaft when accidentally dropped or when starting the motor and the upper brace and arm rest can be used as a blower wand, stick edger brace and the like.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of a lawn tool illustrating a longitudinal direction for vertical lawn edging operation which is accomplished by having a lateral, vertical and longitudinal control system lead an outer ring of string line filament on a center of rotational symmetry

FIG. 2 is an isometric view of the lawn tool of FIG. 1 illustrating the longitudinal direction for horizontal trimming operation that is carried out by having the lateral and longitudinal control handles and the vertical arm rest congruently move the outer ring of string line filament within a single orthogonal isometry

FIG. 3 is an isometric view of a power source assembly from a motor to a rear section of a power control handle of the lawn tool of FIG. 1 illustrating a vertical arm rest and tool height stabilizer and a partial cut away of a clutch casing to reveal a shaft and motor assembly longitudinal translation stop method

FIG. 4 is a partial isometric view of FIG. 1 and FIG. 2 illustrating a lateral control handle with an adjustable yoke and a partial cut out of the power control handle front section to show the shaft with a lateral and vertical brake system

FIG. 5a is an isometric view illustrating a cutting disk cover that can suspend the outer ring of string line filament

FIG. 5b is a cross sectional view of a cutting disk spool of FIG. 5a illustrating a wheel that stabilizes an outer segment and inner ring of string line filament

FIG. 6 is an isometric view of FIG. 1 and FIG. 2 illustrating a longitudinal power control skid, a lateral control handle skid and a cutting guard skid shown stabilizing the shaft from bending and helping to prevent fingers, toes and other body organs from further risk of injury

FIG. 7a is a partial side view of FIG. 1 and FIG. 2 illustrating an operator with a left handed overhand grip on the lateral handle while having both elbows back when suspending the lawn tool in equilibrium in a left shoulder harness arrangement

FIG. 7b is an opposite side view of FIG. 7a illustrating the operator orientated in a right shoulder harness position with a right handed lateral grip while continuing to keep both keep both rear elbows back when suspending the lawn tool in equilibrium in a right shoulder harness position

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

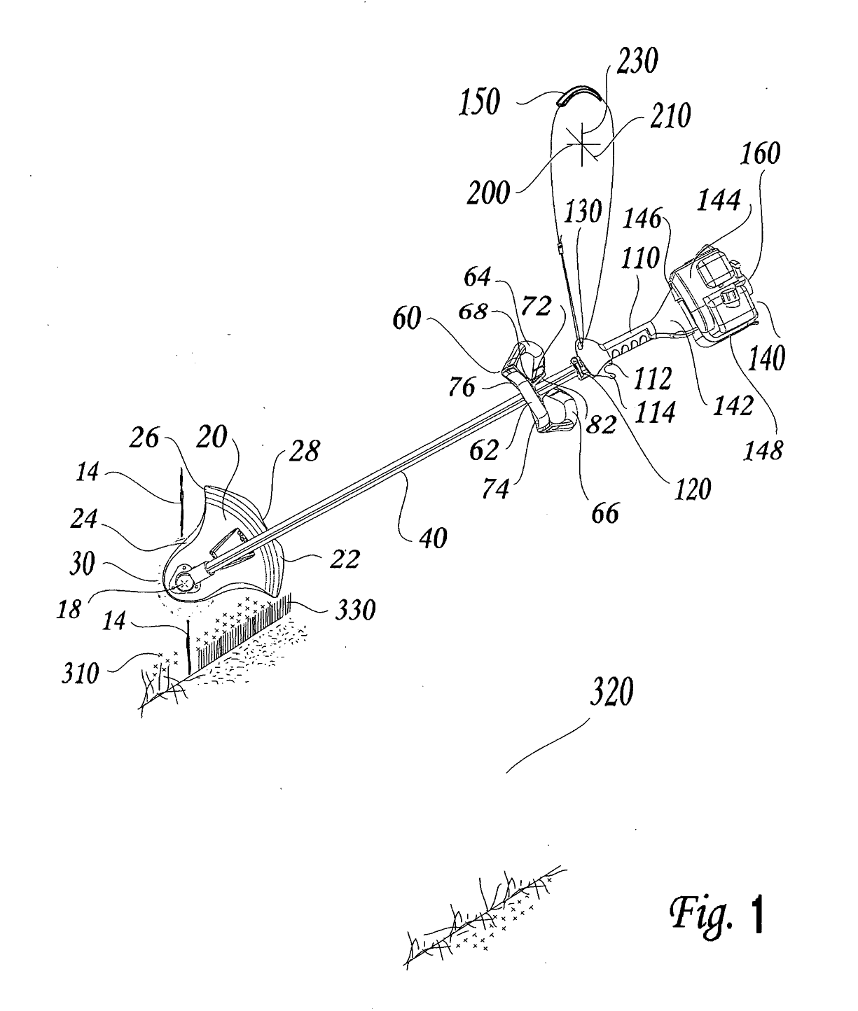

Referring to FIG. 1, grounds maintenance tool 10 capable of being worked by an operator in a vertical lawn edging 330 position generally comprising a lateral control handle 60 and a longitudinal power control handle 110 to stabilize the operation along a shaft 40 center of rotational symmetry. The grounds maintenance tool 10 is capable of maintaining an orthogonal operating isometry for lawn edging 330 on a substantially identical linear or forward progressing trimming transport route 320. The grounds maintenance tool can be held by hand or from an auxiliary vertical shoulder harness 150 which can be made cable or elastic retractable (not shown in FIG. 1) to fit mostly inside the power control handle 110 with sound engineering judgment. The auxiliary shoulder harness 150 connects the shaft 40 to a fixed point to substantially hold the grounds maintenance tool 10 in orbital equilibrium on a vertical axis 230 within an orthogonal operating isometry and can interchange to either side of an operator. The lawn tool 10 having an upright power source 140 to run a motor 160, but the power source 140 can be substituted with electrical, hybrid, renewable, human or other energy sources to transmit steady drive train power on a longitudinal axis in front of an operator from reasonable elbow height to about ground level. The grounds maintenance tool 10 is substantially balanced in orbital equilibrium from the motor 160 to the tip of a string line filament 14 on the shaft 40 center of rotational symmetry. In a preferred embodiment of FIG. 1 whereby the grounds maintenance tool 10 work cycle can last up to an hour or more, the motor 160 fuel tank 140 can be filled up with fuel when needed for lawn care so that a tool origin 18 slightly vertically pivots by a comfortably compressed arm from an auxiliary shoulder harness 150 about eight and one-half inches off the ground. As the fuel power source 140 is transferred to a cutting disk 30 to do most of the work at or near ground level, the grounds maintenance tool 10 slowly pivots downward for safekeeping to alert the operator when the power source is getting low on fuel. There is a lower power skid 148 that covers the lower part of the power casing 144 to protect the grounds maintenance tool 10 from vertical jolts. The cutting disk 30 will lock within an orthogonal operating isometry on identical transport routes to lawn edge diagonally away from an operator by about the same angle as the shaft 30 trimming angle. Using the same analogy for long term electrical lawn care, the tool origin 18 can be kept at an optimal level by facilitating a backup battery 140 power source to substitute as the motor 160 fuel 140 power source. Furthermore, the motor 160 and motor casing 144 are connected to the clutch casing 142 with a saddle arm support, that is, a vertical tool lever 146 that is formed at an upper end by an ergonomic cavity where the power control handle 110 operatively merges to an apex which enhances lift strength at the tool origin to raise the string line filament 14 to a secure position where it is suppose to obey an elasticity limit. The vertical tool lever 146, shown in more detail below, is immediately releasable from a fore arm from or can continue to help rest rearward muscles. The vertical tool lever 146 is interchangeable with left and right fore arms. The vertical lever 146 can raise and lower the power control handle 110 and motor 160 to create upward or downward stability for vertical lawn edging and horizontal grounds trimming.

Still referring to FIG. 1, the motor 160, is able to transmit energy to and from a grounds surface by means of the string line filament 14 rotating and translating on the grounds maintenance tool 10 center of rotational symmetry. The center of rotational symmetry permits the grounds maintenance tool 10 center of mass to be contained along substantially identical horizontal lawn trimming 310 and vertical 330 edging transport routes 320 which is an orthogonal path of least resistance. By definition, the power control handle 110 is a two-way, right or left handed longitudinal grip 111 that typically minimizes interferences at the tool origin 18 by a stabilizing framework applied to the center of rotational symmetry longitudinal axis 200. In addition, the lateral control handle 60 helps to control disturbances at the tool origin 18 by applying a stabilizing framework to the center of rotational symmetry lateral axis 210. Finally, the auxiliary harness 150 helps to control natural vertical forces and other imbalances at the tool origin 18 by applying a vertical stabilizing framework 230 to the center or rotational symmetry vertical axis 230. An auxiliary cam lock 120 can compress the power control handle 110 and the shaft 40 to a stop mode prevent translation and rotation of the shaft 40, but other clamps can be incorporated with the application as described in more detail below. The power control handle 110 provides a main speed trigger 114, but may also provide a secondary speed trigger 112 to hold an index finger in almost identical spots. It is important to note that the grounds maintenance tool 10 longitudinal 210 and lateral 220 frameworks substantially impose onto one another whenever reciprocating lawn care operation from vertical lawn edging to horizontal grounds trimming while keeping the vertical axis 230 somewhat in place during the orthogonal isometry fold. The grounds maintenance tool 10 may offer minimal frictional interference when the lateral 220 and longitudinal 210 axes mesh together with the vertical axis 230. Furthermore, a cutting guard 20 consists of a base skid 22 that glides on transport 320 declines and is likely to slow movement when dropped on transport 320 inclines, side walls 24 with aerodynamic bends, a back trimming wall with extended wings 26 to open up the cutting area and a cutting guard rest 28 when starting the lawn tool that are placed on a line of symmetry from the shaft 40 center of rotational symmetry which provides a low lying smaller amount of frictional disturbances.

Referring again to FIG. 1, the lateral control handle 60 is a six-way or more grip for horizontal trimming 310 or perpendicular edging 330 of lawns when considering a frontal right handed edging grip 66, a frontal left handed edging grip 64 and a frontal trimming grip 62 can be interchanged with a rearward power control 110 grip 108. This allows lawn care providers to take on several different muscle exercises with twelve different overhand, underhand and lateral operational grips for about forty minutes of heavy-duty lawn care. Although these grounds maintenance tool 10 muscle exercises are intended for reducing the concentration of energy which is hard to predict, the inventor encourages an operator to get medical attention and exercise therapy from experts, consider altering their work, rest, leisure, and diet habits, bring all lawn tools in for repair or replacement within all warrantee anniversary dates; especially with lightweight tools that have a lot of torque and immediately begin reading lawn tool owner manuals and other publications whenever unreasonable pain persists for weeks. Having said that, the well balanced orthogonal operating framework facilitates precise grounds maintenance tool 10 orientation, offering two extra turfgrass walking surfaces for lawn edging transport which will add up to about thirty more minutes of softer foot and torso relief for a tired, weak or slightly pain developing worker. The lateral control handle 60 consists of lightweight, yet durable left 74 and right 76 spokes evenly divided by a symmetrical yoke 82 to uniformly manage energy forces acting on either a left 64 or right 66 lawn edging and trimming 62 frontal grips. The right 72 and left 74 side spokes are secured on both sides of the horizontal trimming grip 62 for strong suspension and support of the grounds maintenance tool 10. In addition, the right 72 and left 74 side spokes act as a bar arm for a palm to grip the lateral control handle 60 in a lateral torque position when cutting thicker vegetation. The yoke 82 may consist of an inner 68 and an outer 72 fastener that compresses the lateral control handle 60 on a center of percussion. The inner 68 and outer 72 yoke 82 fasteners may be permanent or may allow an operator to make slight grip adjustments with a height adjuster 70 to alter the trimming grip 62 from the horizontal lawn surface.

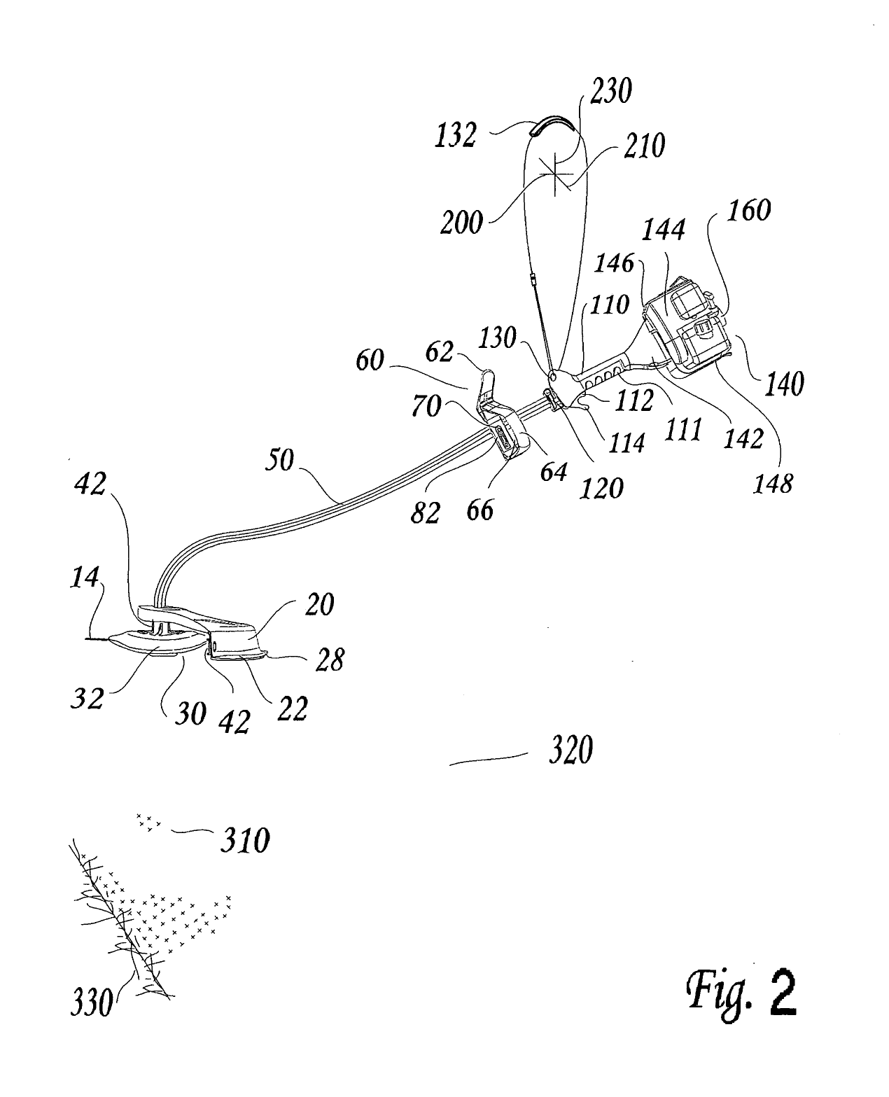

Referring now to FIG. 1 and FIG. 2, the grounds maintenance tool 10 maintains an orthogonal operating isometry for horizontal lawn trimming 310 along a similar edging transport route 320. The grounds maintenance tool 10 has the lateral control handle 60 and the longitudinal power control handle 110 on the center of rotational symmetry for a bow shaft 50 to be held in equilibrium on the center of rotational symmetry like the shaft. A bowed shaft 50 can be held in similar or improved equilibrium with the same center of rotational symmetry as the straight shaft 40 described in FIG. 1. It is important to note that a solid (not shown) or tubular drive shaft (not shown) tend to loose their balance more than a flexible drive shaft (not shown) after be subjected to heavy long-term torque which doesn't necessarily make the grounds maintenance tool 10 seen in FIG. 1 with a straight shaft 40 better equipped than having a well balanced bow shaft 50; especially when energy is difficult to measure over a long period. The bow shaft 50 is more capable of stabilizing a flexible drive shaft (not shown) with a more uniform downward wave frequency whereby the symmetrical bends are easier to gather grease, compress evenly along a flexible shaft membrane (not shown) and promote more air tunnel qualities. The lighter grounds maintenance tool 10 and bow shaft 150 design makes the adjustable and sturdy lateral control handle 60 more worthy of multiple grounds use. In addition to the bow shaft 50 substitution, the grounds maintenance tool 10 may in some cases be equipped with a wide cutting disc 30 or the like to bring the string line filament 14 inertia out to a safer elasticity limit point while keeping its length about normal. Bringing the string line filament 14 inertia out doesn't get in the way of the cutting guard 20 and is significantly protected by the symmetrical skid 22. In another embodiment, the power control handle 110 may be equipped with a lightweight retractable harness 150 cable.

Still referring to FIG. 2, the lateral control handle 60 generally orientates a three spoke wheel into a stable horizontal grip position by the auxiliary height adjuster 70 to coincide with the bow shaft 50 congruent horizontal trimming and vertical edging operations with respect to the lateral 220, longitudinal 210 and vertical 230 operating frameworks. Therefore, frontal grip 62 used for lawn trimming will always align parallel with the cutting plane as demonstrated in FIG. 1 and FIG. 2. Also, the frontal left grip 64 and right grip 66 used for lawn edging will be perpendicular to the grounds maintenance tool 10 horizontal 310 trimming 310 or vertical 330 edging plane when being held over a flat surface by an operator. The cutting guard 20 skid 22 rest 28 on a grounds surface by about the same angle as the bowed shaft 50. In addition to the cutting guard 20 providing a skid 22, the yoke 82 provides a rounded skid base to keep the shaft from bending or collapsing when pulling up on a motor 140 start rope or when accidentally or have to let go of the grounds maintenance tool 10. The yoke 82 interior is made of brake resistant material and may have softer gel material added internally. The grounds maintenance tool 10 motor 160 and power source 140 casing 146 can be supported by the clutch casing 142 saddle rest 146 to also raise and lower the bow shaft 50, tool origin 18 string line filament 14.

Referring to FIG. 2 and FIG. 1, the cutting guard 20 provides a symmetrical mount for a knife 44 with slightly larger serrated arcs and semi-circle bladed claw ends to chop through a standard sized 0.09 diameter string line filament at a stable length. The cutting guard 20 further consists of radian wall protection from about the tool origin 18 to where the wings 26 end. The cutting guard 20 protection is generally two times the straight 40 or bowed 50 shaft hypotenuse angle when held on the center of rotational symmetry 200 where the wings 26 end. The cutting guard side walls are aerodynamically folded to flare out back towards the cutting guard skid 22. Most importantly, one or more of the cutting guard 20 edges operatively line up to the lawn surface orthogonal operating isometry

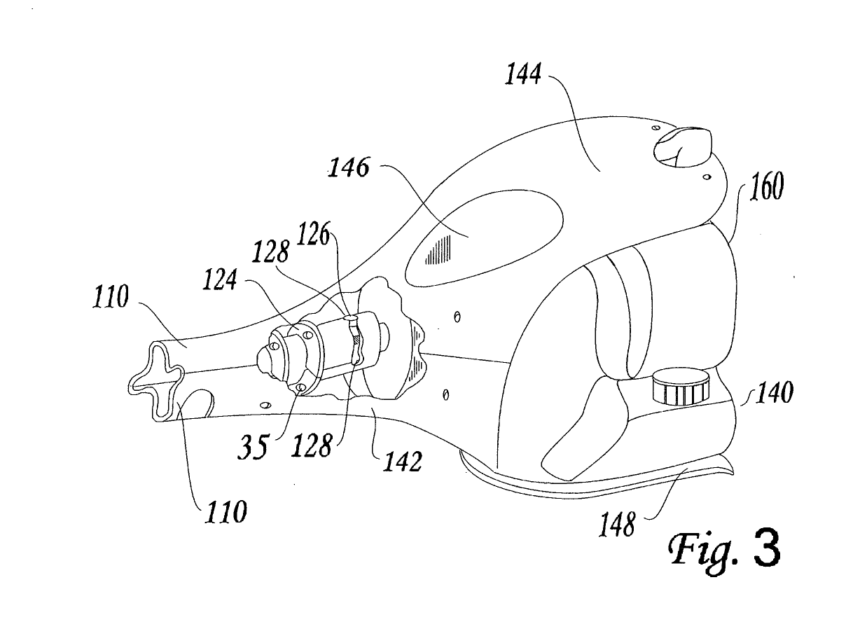

Referring to FIG. 3, the grounds maintenance tool 10 motor 160 clutch casing 142 provides bayonet 128 indents for the trimming 310 and edging 330 orthogonal operating isometries. The bayonet 128 and a button lock 126 longitudinal framework 310 locks are needed to prevent the straight 40 or bowed 50 shaft from slipping out of the power control handle 110. In addition, the bayonet 128 and button lock mechanism is positioned at the end of the straight 40 or bowed 50 shaft to keep the center of rotational symmetry as rigid as possible and to allow memory flexing of bayonet material. Dynamic rings 124 consist of evenly placed apertures to allow motor cables (not shown) to transfer through the power control handle without getting pinched within the power control handle 110. The motor 160 casings 144 and clutch casing 142 apexes provides ample room and slack for the longitudinal arm support 146 to maneuver the grounds maintenance tool 10 safely. The upper brace and arm rest 146 permits about five to one ratio height adjustments to the tool assembly for less fatigue. The upper brace and arm rest 146 helps to stabilize lateral swing motion. The upper brace and arm rest is less likely to absorb vibration because of gravity. The motor 160, the power source 140, the power control handle 110 and upper brace and arm rest 146 can substitute to hold a blower, a metallic stick edger with a wheel or the combination. upper arm brace can substitute

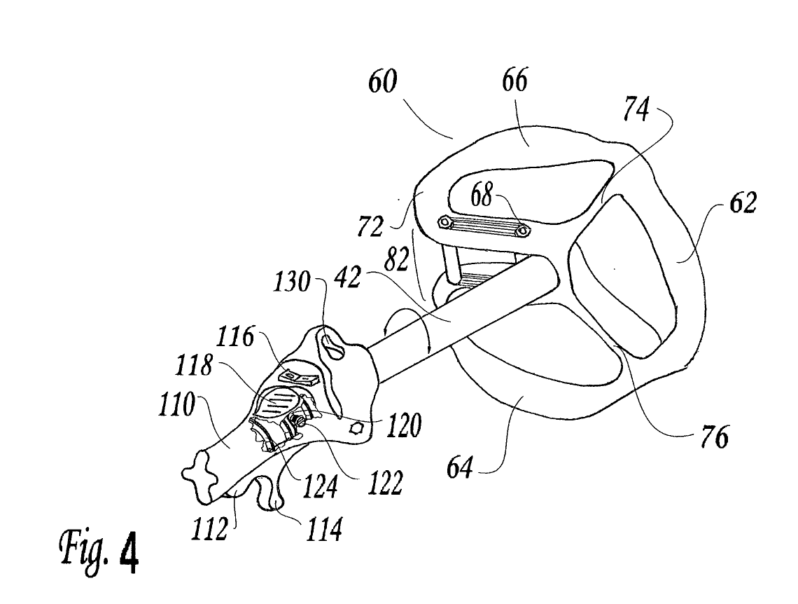

Referring to FIG. 4 and reverting back to FIG. 1 and FIG. 2, a congruent orthogonal isometry is facilitates by the lateral control handle 60 being transformed from a trimming grip 62 to a congruent left handed grip 66 position for lawn edging 330 (not shown) while the power control handle 110 main 114 and secondary 112 speed trigger controls maintain a comfortable position for an index finger (not shown). The straight 40 or bowed 50 shaft (both not fully shown) can be unlocked by an auxiliary brake 120 which is released by a thumb button lock 118 to quickly rotate or lock any of the right edging 64, left 66 edging and dual trimming 62 grips into place. Support rings 124 are uniformly placed to reduce energy impulses and may be coated with an elastic material. The auxiliary brake 120 can be manually tightened by an adjustment screw 122 if and when the brake 120 starts to loose its powerful grip. An on/off switch 116 and the like as well as the harness aperture 130 and the button lock 118 maintain a safe upright position when the shaft rotates. The power control handle 110 is suspended firmly by lightweight inner ring supports 124 that assist with holding the shaft in equilibrium. It is important to note that the left 74 and right spokes 76 can be used as a lateral bar arm in the trimming 310 mode of operation to cut through thick brush. An operator can bring their nearest thumb and index finger around the trimming grip 62 interior section at the top of the nearest left 74 or right spoke 76 in an adjacent position while holding the remaining fingers around the nearest left 66 or right 64 edging grip lower neck. The slightly slanted left edging 66, right edging 64 and trimming 62 grips permit a hand hold a very strong lateral grasp on the lateral control handle because the thumb and palm is mostly utilized throughout the process. The lateral 60 and power 110 control handles substantially align with the operator's forward and rearward hand holding orientations.

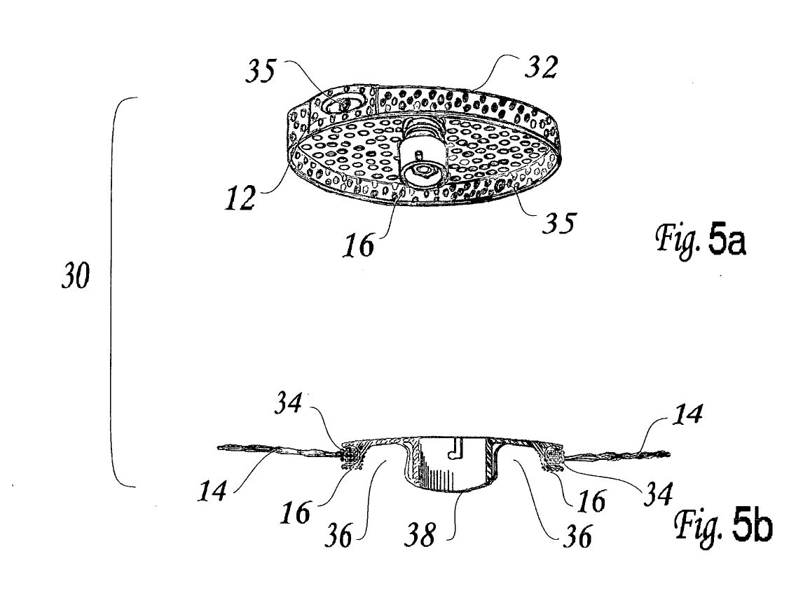

Referring to FIG. 5a and FIG. 5b, the cutting disk 30 provides a wide aerodynamic top cover 32 with outer dimples 32, inner odd numbered airfoils 42 to keep vegetation from whipping about the shaft, a wake area 36 for cooling and a cutting spool 34 inner and outer lining drawn out in radius to help the cutting disk 30 obey Hooke's elasticity limit laws for compression and suspension. This is accomplished by putting a significant amount of the inner and outer cutting disk 30 spool 34 near its optimal center of mass of percussion where the inner string line filament 14 spool 34 ring is less likely to constrict or be elastic and the outer string line filament is more likely to stabilize quickly. By drawing the spool 34 out to a reasonable acute elasticity trimming point, the cutting disk 30 holds about the same length of string line filament 14 whereas narrower, less stable cutting discs are more likely to break the string line filament 14 and damage property along tight corners that should be lawn edged instead. A bump and feed skid 38 aligns with the ground surface to help stabilize disturbances with a spring loaded string line filament 14 release that assists with extending the string line filament 14 through one or more apertures 35 into one or more auxiliary barrels 12. The auxiliary barrels 12 can be elongated to different sized airfoils to assist with stabilizing the interior string lawn filament 14 during lawn edging 330 and trimming 310 operation. The cutting disk 30 wake region 36 combines cooler air with stable air pressure. It is important to note that the barrels 12 will help reduce string line from coiling back into the cutting disk 30 spool when breaking at a distal end. A universal cutting head can substitute for the cutting disk 30 auxiliary unit. The disk cover 32 provides odd numbered airfoils 42 to untangle vegetation, provide structural support and create air movement with optimal energy loss near the tool origin. The cutting disk 30 is about the same weight as conventional cutting heads, but the outer central mass provides more inertia for the same amount of energy as inner central mass cutting heads. The small dimples 16 provide good structural support while reducing noise and material weight. The dimples 16 will further keep dust and debris dispersing away from the outer surface of the cutting disk 30.

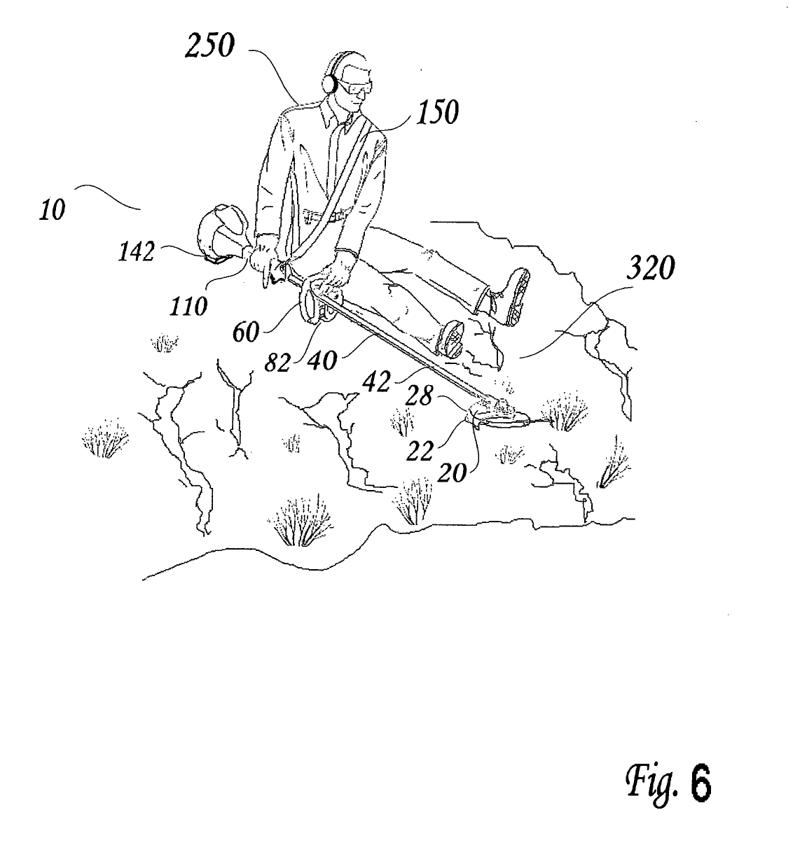

Referring to FIG. 6, the grounds maintenance tool 10 provides some assistance when a person has to react to a fall when a motor 148, yoke 82 and cutting guard 22 skid are dropping while a person 250 is attempting to regain their balance. An observation of the person 250 and the grounds maintenance tool 10 falling is a demonstration of why three dimensional equilibrium of two objects being dropped at about the same time is important. It is important to note that the grounds maintenance tool 10 is likely to provide lift at the cutting guard 20 end of the shaft 40 after substitute bull handles (not shown) are resisted by pull back and downward forces when an operator slips on a declining slope which may cause the person 250 to move under an elevated fast rotating saw blades known to the art. Safety risks can actually can get worse when the shaft 40 buckles to the earth and prevents an index finger from deactivating the speed trigger. Accordingly, the person 250 can apply some symmetrical resistance to the straight shaft 40 which is more likely to help the person suspend themselves on the longitudinal 210, lateral 220 and vertical 230 operating framework in an imbalanced situation. Without the lateral handle 60 skid 82, a person's 250 dropped weight is strong enough to bend the straight shaft 40 downward to cause significant damage. Furthermore, the yoke 82 skid prevents the person's 250 weight jamming an index finger from getting into the ground at the speed trigger 114 wide open throttle. Having the motor skid 142, the lateral control handle skid 82 and the cutting guard skid 22 substantially aligned on something similar to a ski slope may help to avoid serious lawn care accidents. Furthermore, the rear motor 148, yoke 82 and cutting guard 22 skids are bent down slightly which slows backward momentum when the person 250 transports 320 back up the slope.

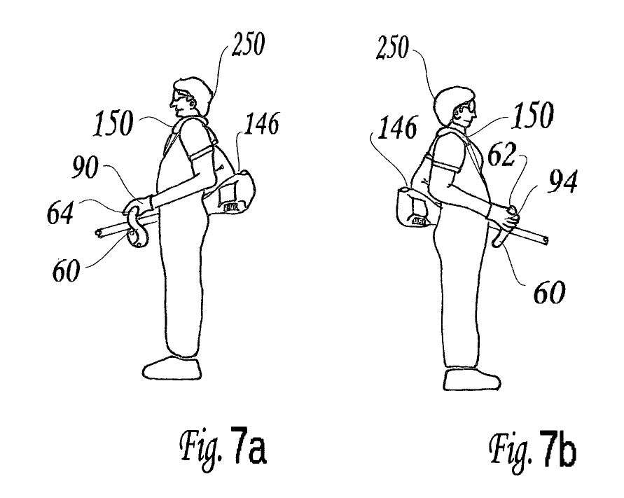

Referring to FIG. 7a and FIG. 7b a person 250 is holding onto a section of the grounds maintenance tool 10. The person 250 in FIG. 7a is using an overhand grip 90 to hold the lateral control handle 60 right or left handed trimming grip 64. The person 250 in FIG. 7b is using a lateral grip 94 to hold the lateral control handle 60 right or left handed trimming grip 64. In each FIG. 7a, and 7b case, the person 250 has their elbows slightly behind their torso to prevent fatigue and to be in a ready press or power alley position. Each grip can be initially applied to four or more trimming and edging operations, keeping in mind that grips should be interchanged frequently. It appears beneficial to interchange these overhand 90 and lateral 94 grips as much as possible; especial if fatigue and pain regularly set in. It is important to note that the lateral 94 and overhand 90 grips can alternate during one operating framework. Furthermore, the vertical lawn edging plane 330, as seen in FIG. 1, is precise to allow the transport route 320 to be reversed so that the person 250 can walk on softer grass during lawn edging. Therefore, an operator is able to work the grounds maintenance tool 10 on a firm or soft transport 320 route, he or she can hold the lateral control handle 60 with either an overhand 90 or lateral 94 spoke hand held grip and he or she may accomplish this with either a trimming 62, right 64 or left 66 operating grip. This combination of grips makes it convenient to exercise different muscle groups to make work more enjoyable and rewarding. However, the best advice one can give about a handheld grounds tool invention is to follow and compare all lawn tool owners manuals whenever making decisions about extremely effective, yet fast rotating power tools.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A grounds maintenance tool comprising:
a lawn tool consisting of a power source;
the power source having means to transmit power from a shaft to a cutting disk or the like on a center of rotational symmetry;
the cutting disk having means to lock within an orthogonal operating isometry on identical transport routes;
the power source maintains an upright operative position within the orthogonal operating isometry;
the power source generally supply energy to a motor;
the power source contained within a power casing;
the power casing connected to an upper brace and arm rest;
the upper brace and arm rest having means to lever blower wands and the like;
the power casing connected to a lower power skid;
the power casing connected to a power control handle;
the power control handle operatively connected to the shaft on a longitudinal axis of the orthogonal operating isometry;
the power control handle having inner ring supports that slightly compress onto the shaft;
the power control handle having a longitudinal grip;
the power control handle maintains congruent operative orientation with the motor, arm rest and power source;
the longitudinal grip having means for an operator to stabilize longitudinal operation with a rearward right or left hand;
the longitudinal grip having means of maintaining significant downward lateral torque;
the longitudinal grip having means for an operator to react quickly to lateral or vertical imbalances;
the power control handle having a brake or the like to stop the shaft from rotating;
the power control handle having a power trigger with one or more speed controls;
the power trigger having means to keep an index finger held substantially in all the grounds maintenance tool operating frameworks;
the power control handle having an aperture that connects an auxiliary shoulder harness to the lawn tool;
the auxiliary shoulder harness having means to the shaft on a vertical axis of the orthogonal operating isometry;
the auxiliary shoulder harness having means to interchange the lawn tool to either side of the operator;
a lateral control handle connected to the shaft on a lateral axis of the orthogonal operating isometry;
the lateral control handle having a horizontal grip for trimming;
the horizontal grip can be held by either a right or left hand;
the horizontal grip can be held by either an overhand or lateral grip;
the horizontal grip having means for an operator to stabilize the lawn tool lateral operation with a forward left or right hand;
the horizontal grip having two adjacent side spokes;
the side spokes providing a bar for an operator to grasp onto with a lateral grip;
the lateral control handle having a right grip;
the right grip having means for an operator to lawn edge diagonally to the right of the transport route with a forward right hand grip;
the lateral control handle having a left grip;
the left grip having means for an operator to lawn edge diagonally to the left of the transport route with a forward left hand grip;
the lateral control handle having a yoke;
the yoke having means, for an operator to hold the shaft in equilibrium in all the lawn tool operating frameworks;
the yoke may or may not be coated with an elastic gel material;
the yoke having a handle skid;
the lateral control handle right grip having means for the operator to lawn edge with a overhand or lateral grip from a right or left handed position;
the lateral control handle left grip having means for the operator to lawn edge with a overhand or lateral grip;
the lateral and power control grips substantially align with the operator's forward and rearward hand holding orientations;
the cutting disk bringing the string line filament inner and outer spool out in radius to obey compression and suspension elasticity laws;
the cutting disc is able to stabilize quickly;
the cutting disc having one or more cutting disc barrels;
the cutting disc having means to hold about the same length of string line filament as cutting heads known to the art;
the cutting disk having a symmetrical cutting guard;
the cutting disk having a disc cover;
the disk cover having aerodynamic airfoils;
the disk cover having aerodynamic dimples;
the airfoils having means to untangle vegetation;
the airfoils provide structural support for the string line filament bump and feed skid;
the inverted trough provides a wake area to cool off the cutting disk;
the airfoils substantially reduce noise with respect to linear airfoils known to the air;
the dimples reduce tool weight;
the dimples keep dust away from the spool;
the cutting guard having means to chop off string line with a bladed claw;
the cutting guard radian is generally two times the shaft hypotenuse angle;
the cutting guard substantially aligns with the lawn surface and lawn edge;
the cutting guard side walls are aerodynamically folded towards a back wall;
the back wall having small wings that flare out to prevent debris from dispersing towards the operator;
the cutting guard having a tool skid that glides the grounds maintenance tool forward ground movement;
the tool skid slows the grounds maintenance tool backward ground movement;
the grounds maintenance tool having the power skid, the handle skid and the tool skid all line up to suspend the shaft when accidentally dropped; and
the grounds maintenance tool may or may not be mounted to a universal grounds support wheel or skid.

2. A process for A grounds maintenance tool a lawn tool consisting of a power source;
a lawn tool consisting of a power source;
the power source having means to transmit power from a shaft to a cutting disk or the like on a center of rotational symmetry;
the cutting disk having means to lock within an orthogonal operating isometry on identical transport routes;
the power source maintains an upright operative position within the orthogonal operating isometry;
the power source generally supplies energy to a motor;
the power source contained within a power casing;
the power casing connected to an upper brace and arm rest;
the arm rest having means to lever blower wands and the like;
the power casing connected to a lower power skid;
the power casing connected to a power control handle;
the power control handle operatively connected to the shaft on a longitudinal axis of the orthogonal operating isometry;
the power control handle having inner ring supports that slightly compress onto the shaft;
the power control handle having a longitudinal grip;
the power control handle maintains congruent operative orientation with the motor, arm rest and power source;
the longitudinal grip having means for an operator to stabilize longitudinal operation with a rearward right or left hand;
the longitudinal grip having means of maintaining significant downward lateral torque;
the longitudinal grip having means for an operator to react quickly to lateral or vertical imbalances;
the power control handle having a brake or the like to stop the shaft from rotating;
the power control handle having a power trigger with one or more speed controls;
the power trigger having means to keep an index finger held substantially in all the grounds maintenance tool operating frameworks;
the power control handle having an aperture that connects an auxiliary shoulder harness to the lawn tool;
the auxiliary shoulder harness having means to the shaft on a vertical axis of the orthogonal operating isometry;
the auxiliary shoulder harness having means to interchange the lawn tool to either side of the operator;
a lateral control handle connected to the shaft on a lateral axis of the orthogonal operating isometry;
the lateral control handle having a horizontal grip for trimming;
the horizontal grip can be held by either a right or left hand;
the horizontal grip can be held by either an overhand or lateral grip;
the horizontal grip having means for an operator to stabilize the lawn tool lateral operation with a forward left or right hand;
the horizontal grip having two adjacent side spokes;
the side spokes providing a bar for an operator to grasp onto with a lateral grip;
the lateral control handle having a right grip;
the right grip having means for an operator to lawn edge diagonally to the right of the transport route with a forward right hand grip;
the lateral control handle having a left grip;
the left grip having means for an operator to lawn edge diagonally to the left of the transport route with a forward left hand grip;
the lateral control handle having a yoke;
the yoke having means for an operator to hold the shaft in equilibrium in all the lawn tool operating frameworks;
the yoke may or may not be coated with an elastic gel material;
the yoke having a handle skid;
the lateral control handle right grip having means for the operator to lawn edge with a overhand or lateral grip from a right or left handed position;
the lateral control handle left grip having means for the operator to lawn edge with a overhand or lateral grip;
the lateral and power control grips substantially align with the operator's forward and rearward hand holding orientations;
the cutting disk bringing the string line filament inner and outer spool out in radius to obey compression and suspension elasticity laws;
the cutting disc is able to stabilize quickly;
the cutting disc having one or more cutting disc barrels;
the cutting disc having means to hold about the same length of string line filament as cutting heads known to the art;
the cutting disk having a symmetrical cutting guard;
the cutting disk having a disc cover;
the disk cover having aerodynamic airfoils;
the disk cover having aerodynamic dimples;
the airfoils having means to untangle vegetation;
the airfoils provide structural support for the string line filament bump and feed skid;
the inverted trough provides a wake area to cool off the cutting disk;
the airfoils substantially reduce noise with respect to linear airfoils known to the air;
the dimples reduce tool weight;
the dimples keep dust away from the spool;
the cutting guard having means to chop off string line with a bladed claw; edge with a overhand or lateral grip from a right or left handed position;
the lateral control handle left grip having means for the operator to lawn edge with a overhand or lateral grip;
the lateral and power control grips substantially align with the operator's forward and rearward hand holding orientations;
the cutting disk bringing the string line filament inner and outer spool out in radius to obey compression and suspension elasticity laws;
the cutting disc is able to stabilize quickly;
the cutting disc having one or more cutting disc barrels;
the cutting disc having means to hold about the same length of string line filament as cutting heads known to the art;
the cutting disk having a symmetrical cutting guard;
the cutting disk having a disc cover;
the disk cover having aerodynamic airfoils;
the disk cover having aerodynamic dimples;
the airfoils having means to untangle vegetation;
the airfoils provide structural support for the string line filament bump and feed skid;
the inverted trough provides a wake area to cool off the cutting disk;
the airfoils substantially reduce noise with respect to linear airfoils known to the air;
the dimples reduce tool weight;
the dimples keep dust away from the spool;
the cutting guard having means to chop off string line with a bladed claw;
the cutting guard radian is generally two times the shaft hypotenuse angle;
the cutting guard substantially aligns with the lawn surface and lawn edge;
the cutting guard side walls are aerodynamically folded towards a back wall;
the back wall having small wings that flare out to prevent debris from dispersing towards the operator;
the cutting guard having a tool skid that glides the grounds maintenance tool forward ground movement;
the tool skid slows the grounds maintenance tool backward ground movement;
the grounds maintenance tool having the power skid, the handle skid and the tool skid all line up to suspend the shaft when accidentally dropped; and
the grounds maintenance tool may or may not be mounted to a universal grounds support wheel or skid.
